(19) United States
(12) Patent Application Publication
(10) Pub. No.: US 2015/0215161 A1
(43) Pub. Date: Jul. 30, 2015

(54) NEAR FIELD COMMUNICATION BASED BOOTSTRAPPING

(71) Applicant: Cisco Technology, Inc., San Jose, CA (US)

(72) Inventors: Balasundaram NANTHISAMY, Bangalore (IN); Naveen Kumar KANAGARAJ, Bangalore (IN); Rajesh Tarakkad VENKATESWARAN, Bangalore (IN)

(73) Assignee: Cisco Technology, Inc., San Jose, CA (US)

(21) Appl. No.: 14/163,348

(22) Filed: Jan. 24, 2014

(51) Int. Cl. H04L 12/24; H04W 4/00

(52) U.S. Cl. CPC H04L 41/0803; H04W 4/008

(57) ABSTRACT

Embodiments described herein permit a mobile device to transfer a configuration package to a network device which automatically configures (i.e., without user intervention) the network device using a bootstrapping process. Specifically, the mobile device may use near field communication (NFC) to transfer the configuration package to the network device. The configuration package may include the information required to bootstrap the network device such as an operating system (OS) image and configuration information (e.g., user name, passwords, etc.). Once NFC is established, the mobile device transfers the configuration package to the network device which then begins the bootstrap process using the data contained in the package.

### TECHNICAL FIELD

Embodiments presented in this disclosure generally relate to bootstrapping a network device using near field communication. More specifically, embodiments disclosed herein use near field communication to transfer a configuration package from a mobile device to the network device.

### BACKGROUND

A network device (e.g., router, switch, server, and the like), by default, may not be configured to connect to any networks. For example, a bank may purchase a new router which it desires to connect to its private network (e.g., a VLAN or VPN). Before the router can be used to provide connectivity to the private network, a network engineer needs to configure the device for the first time. This typically requires the network engineer to be located at the router and use, for example, a user interface associated with the router to enter in a series of commands that enable the router to connect to the desired network or networks. Stated differently, the router may be unable to be configured remotely thereby requiring a trained professional to be physically near the router.

Requiring a network engineer to set up a network device, however, may greatly increase the cost of adding (or replacing) devices in a network. Because the configuration may require special training (e.g., special network certifications), this reduces the number of people (i.e., network engineers) capable of configuring a network device. Moreover, these network engineers may be too busy to timely travel to the location where the network devices are to be installed and configure these devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a system for bootstrapping a network device using near field communication, according to one embodiment described herein.

FIG. 2 is block diagram of a system for bootstrapping the network device using a configuration package transmitted from the mobile device, according to one embodiment described herein.

FIG. 3 is a flow chart for bootstrapping the network device using near field communication, according to one embodiment described herein.

FIG. 4 is a flow chart for using authorization information to load the configuration package onto the intended network device, according to one embodiment described herein.

FIG. 5 is a system for connecting a bootstrapped network device to a network, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DESCRIPTION OF EXAMPLE EMBODIMENTS

### Overview

One embodiment presented in this disclosure is a network device that includes a near field communication module configured to receive, using near field communication, a configuration package comprising an operating system image and configuration settings. The network device also includes a processing element configured to perform a bootstrapping process using the operating system image and connect the network device to a network using the network configuration settings in the received package.

Another embodiment in the present disclosure is a method for configuring a network device. The method includes receiving a configuration package on a mobile computing device where the package includes an operating system image and configuration settings. The operating system image and configuration settings are configured to be used in a bootstrapping process by the network device to connect the network device to a network. The method includes transferring the package from the mobile computing device to the network device using near field communication.

Another embodiment presented in this disclosure is a computer program product that includes computer-readable program code configured to receive a configuration package on a mobile computing device where the package includes an operating system image and configuration settings. The operating system image and configuration settings are configured to be used in a network device in a bootstrapping process to connect the network device to a network. The program code is further configured to transfer the package from the mobile computing device to the network device using near field communication. The computer program product also includes a computer readable medium that stores the computer-readable program code.

### EXAMPLE EMBODIMENTS

Embodiments described herein permit a mobile device to transfer a configuration package to a network device which automatically configures (i.e., without user intervention) the network device using a bootstrapping process. For instance, the mobile device may use near field communication (NFC) to transfer the configuration package to the network device. Generally, NFC is a set of standards for computing devices to establish radio communication with each other by touching them together or bringing them into close proximity, usually no more than a few centimeters or inches. Because of the close proximity between communicatively coupled devices, NFC provides additional security as compared to other short range (e.g., less than 100 meters) device-to-device communication protocols—e.g., Wi-Fi or Bluetooth. Nonetheless, it is specifically contemplated that the embodiments described herein may use other short range communication protocols for transferring the configuration package directly from the mobile device to the target network device.

The configuration package may include the information required to bootstrap the network device such as an operating system (OS) image and configuration settings (e.g., username, passwords, etc.). For example, a NFC-enabled mobile device may be used to transfer the configuration package to the network device which then begins the bootstrapping process using the data contained in the package. Instead of requiring a trained network engineer to configure the network device, using NFC to transfer the configuration package means that any person can bring the mobile device in close proximity to the network device which begins the bootstrapping process. Thus, a trained network engineer is no longer required to be near the network device in order to configure the new device.

In one embodiment, the network or mobile device may provide visual or audio feedback to the user of the mobile device when the bootstrapping process is complete. For example, the network device may include a LED indicator that flashes green when the network device receives the configuration package and/or the bootstrapping process was successful. Thus, even if the user of the mobile device does not have the requisite training, she can still determine whether the bootstrapping process was successful. Furthermore, to minimize potential errors when the configuration package is erroneously transferred to the incorrect network device, the package may include authorization information that ensures only the intended network device performs bootstrapping using the configuration package. For instance, the package may include encoded or encrypted data that requires a specific key to decrypt. If the network device has the wrong key, then it knows the package was intended for another device and can be discarded.

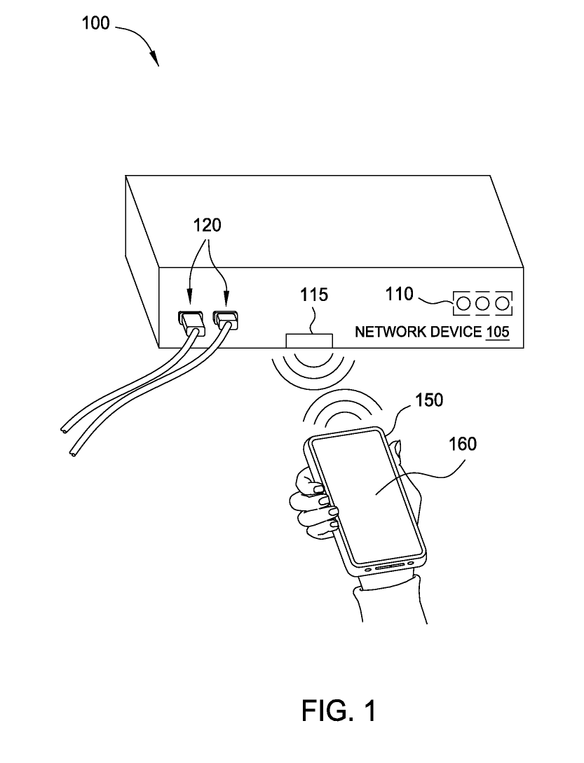

FIG. 1 is a system 100 for bootstrapping a network device 105 using NFC, according to one embodiment described herein. Specifically, the network device 105 may be a new or factory reset network device (e.g., router, switch, hub, and the like) that is currently not configured to connect to network. In one embodiment, a basic or default operating system may be executing on the network device 105. Bootstrapping the network device 105 may include loading a desired operating system onto the device 105 and connecting the device 105 to a network. In one embodiment, this bootstrapping process is performed on a network device 105 that has not previously been configured (e.g., is new or has been factory reset). Unlike where a network engineer may have to manually perform the steps to configure the device 105, bootstrapping occurs automatically once a configuration package is loaded onto the network device 105. After the bootstrapping process is complete, in one embodiment, the network device 105 may have the desired operating system with a communication link to one or more external networks (e.g., LANs or WANs) via the ports 120. Although FIG. 1 illustrates that the ports 120 are wired ports, in other network devices the ports may be wireless or some combination of both.

To receive the configuration package, the network device 105 includes a NFC module 115. This module 115 may include hardware or firmware that permits the network device 105 to receive the configuration package even if a basic operating system (or no operating system) is executing. As shown, the NFC module 115 may be in communication with another NFC module on the mobile device 150. This device 150 may be any portable computing device capable of storing and transmitting the configuration package using NFC. Non-limiting examples of such devices include smart phones, laptops, tablets, and the like.

In one embodiment, both the NFC module 115 and the mobile device 150 may include active NFC components rather than passive components. A passive NFC component (or NFC tag) is one that permits authorized devices to read data but does not itself query other NFC components for information. An active NFC component, in contrast, may send information as well as read information from other NFC-enabled devices. If the NFC module 115 on the network device 105 and the NFC components on the mobile device 150 are both active, the network device 105 and mobile device 150 can exchange information. For instance, the mobile device may transmit the configuration package to the network device 105 and the network device may transmit a confirmation message to the mobile device 150 when the transfer is complete or when the bootstrapping process is performed successfully.

The network device 105 includes indicator lights 110 that may provide feedback to the user of the mobile device 150. For example, a first one of the lights 110 may flash green when the configuration package is successfully received and a second one of the lights 110 may flash green after the bootstrapping process is complete and the network device 110 has been configured. In this manner, the network device 105 may provide basic feedback to the user who may not be a trained network engineer. If, for example, the package is not received (e.g., the user moves the device 150 too far from the NFC module 115 during transmission), the lights 110 may indicate this to the user who can reinitiate the transfer.

The mobile device 150 may also use a display screen 160 to inform the user the status of the package transfer and the bootstrapping process. If any of these events fail, the display 160 may show a message for the user with step-by-step instructions for troubleshooting—e.g., restarting the package transmission, making sure the network device 105 is receiving power, and the like. To provide these updates, the mobile device 150 may receive messages from the NFC module 115 or from secondary communication protocols (e.g., Wi-Fi or Bluetooth). Moreover, although system 100 shows using visual indicators to provide user feedback, in other embodiments, auditory, haptic, or other feedback techniques may be used.

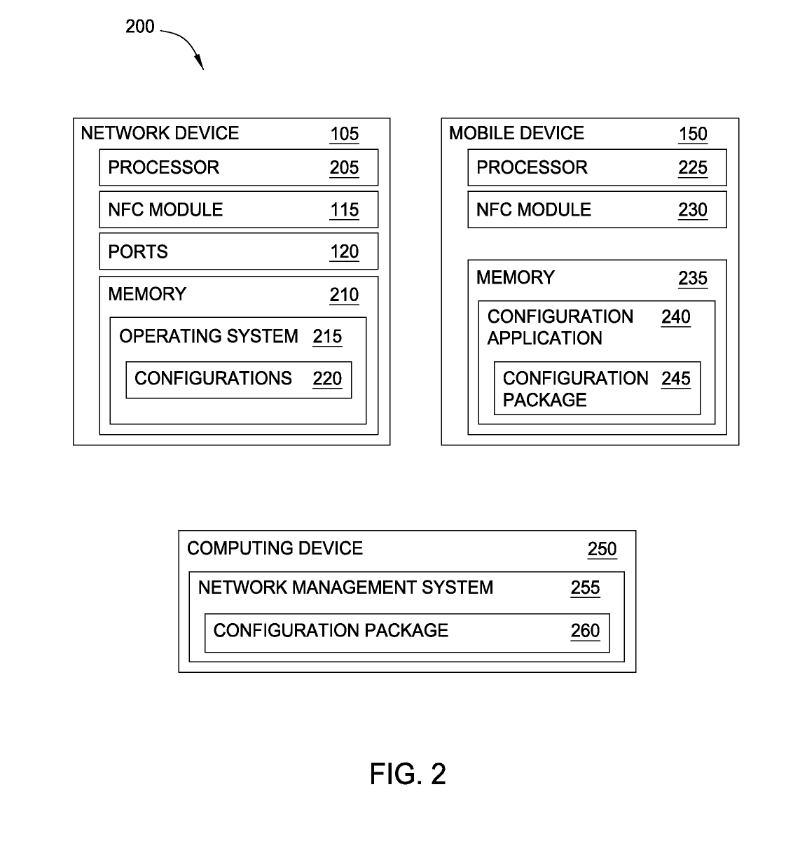

FIG. 2 is block diagram of a system 200 for bootstrapping the network device 105 using a configuration package transmitted from the mobile device 150, according to one embodiment described herein. System 200 also includes computing device 205 which may be used to generate the configuration package 245 that is then loaded onto the mobile device 150. Specifically, the computing device 250 includes a network management system (NMS) 255 that may store information about one or more network (e.g., a business's private network). For instance, the NMS 255 may include network routing information, passwords, network topology, information about the network devices in the network, and the like. In one embodiment, the NMS 255 stores the configuration settings of each device as a file. Using the information stored in the NMS 255, a network engineer may generate the configuration package 245 which is then transferred onto the mobile device 150. A more detailed explanation of how the configuration package may be generated is provided below.

The mobile device 150 includes a processor 225, NFC module 230, and memory 235. The processor 225 may be any general or custom processing element capable of performing the functions herein. For instance, processor 225 may represent a single processor or multiple processors. Moreover, the processor 225 may include any number of processing cores. In one embodiment, the NFC module 230 may include active NFC components for establishing two-way communication with the NFC module 115 on network device 105. Of course, the NFC module 230 may be used for other purposes in addition to communicating with the network device 105 such as purchasing an item or service, sharing device identification information, establishing secure connections, and the like.

Memory 235 may include volatile or non-volatile memory elements that store a configuration application 240 which can be executed by the processor 225. This application 240 may use the NFC module 230 to transfer the configuration package 245 to the network device 105. For example, when the mobile device 150 is moved to a location proximate to the network device 105, the configuration application 240 may display a prompt to the user asking whether the configuration package 245 should be transferred to the network device 105. In one embodiment, the configuration application may be software that is installed on the mobile device 150. Thus, the mobile device may be a smart phone, laptop, or other computing device which may be used to perform any number of tasks. By installing the configuration application 240, the mobile device 150 is then able to load and transfer the configuration package 245 to the network device 150 using the NFC module 230. In this manner, any mobile computing device which includes a NFC module 230 may have an application installed or be configured to transmit the configuration package 245 to the network device 105.

The network device 105 includes a processor 205, NFC module 115, ports 120, and memory 210. Like mobile device 150, the processor 205 may represent any number of processors with any number of processing cores. Moreover, the NFC module 115 may represent hardware (e.g., antenna), firmware, software, or some combination thereof that is capable of receiving the configuration package 245 from the mobile device.

Memory 210 may include volatile or non-volatile memory that stores the operating system 215. In one embodiment, before the configuration package 245 is received, the network device 105 may have a default or basic operating system. The configuration package 245 may include an OS image which is then used to install a desired OS 215 (e.g., a specific version of an OS) onto the network device 105. Moreover, the package 245 may include configuration settings (e.g., network topology, usernames, passwords, and the like) that enable the OS 215 to connect the network device 105 to one or more networks using the ports 120.

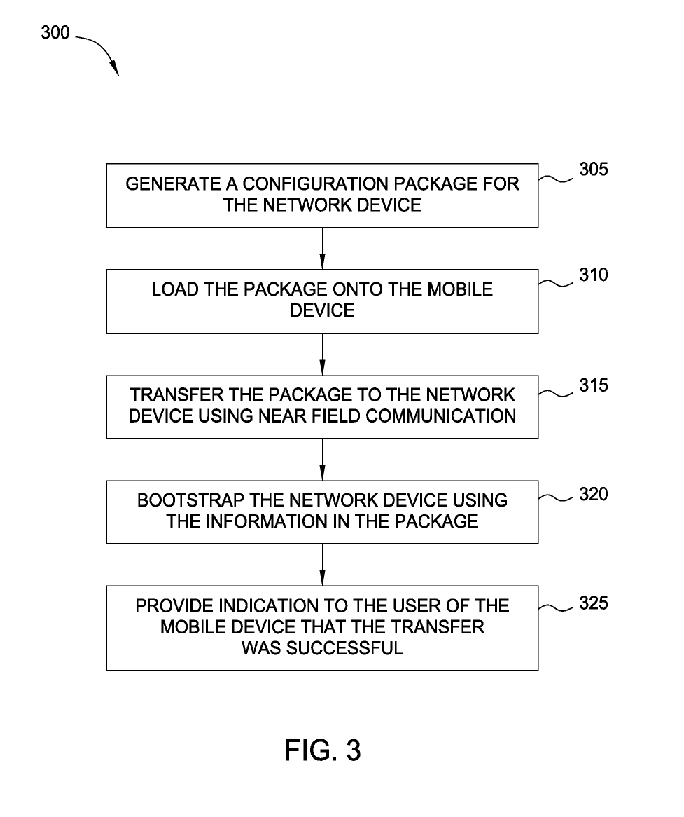

FIG. 3 is a flow chart for bootstrapping the network device using near field communication, according to one embodiment described herein. At block 305 of method 300, a network engineer may use the NMS to generate a configuration package for the network device. The NMS, for instance, may include a user interface that the network engineer uses to generate the configuration package. The network engineer may select an OS image to include in the configuration package. For example, the engineer may select an OS image used by another network device already connected to the network. In this manner, the OS executing on the network devices may be the same (e.g., the same version or have similar configurations) which may increase compatibility between the network devices.

The engineer may also use the NMS to provide configuration settings for the package. These settings may configure the OS, define which ports on the network device should be used, set the baud rate of the ports, provide network passwords, and the like. Stated differently, the network engineer can use the NMS to generate a configuration package that bootstraps the network device and connects the device to a desired network. Once the configuration package is generated, the network engineer may not have to take any further steps. Thus, another person (who does not need to have the same level of training) can then transport the configuration file to the network device.

At block 310, the configuration package is loaded onto the mobile device. In one embodiment, the computing system hosting the NMS may transfer the configuration package to the mobile device. Depending on the size of the package, the package may be sent via any number of communication means. For example, the package could be emailed to the mobile device or uploaded onto a cloud service. Alternatively, the package could be transferred using a flash drive or the mobile device could be directly coupled to the computing system using a cable such as Firewire or USB. Generally, the package may be loaded onto the mobile device using any wireless or wired communication techniques.

At block 315, the mobile device transfers the configuration package to the network device using NFC. The mobile device may include an application that instructs the mobile device user which network device is the target device. For example, the application could display a representative image of the network device or a unique identifier associated with the device that the user can use to identify the device. After doing so, the user then brings the mobile device in close proximity to the NFC module of the network device which initiates the transfer of the configuration package, assuming that the network device is already connected to a power source. The transfer between the network and mobile devices may occur automatically or by prompt by the user. For example, once NFC module on the mobile device discovers the NFC module on the network device, the application may display a prompt asking the user for permission to transfer the package to the network device. The prompt may include identification information associated with the network device to help the user determine whether the network device is the intended recipient or target of the package. Alternatively, the mobile device may transfer the package without user permission once it establishes near field communication with the network device.

Although the present embodiments describe using NFC to transfer the configuration package, other communication techniques are also possible. For example, using a wired communication technique (e.g., plugging the mobile device directly into a USB port of the network device) may also provide similar security advantages as using NFC.

At block 320, the network device performs bootstrapping using the information in the configuration package. As described earlier, the package may include an OS image and configuration settings. Using the OS image, the firmware and/or hardware of the network device may install the OS. Once installed, the network device may reboot and begin executing the OS. While installing the OS or after the OS is executing, the network device may use the configuration settings to connect the network device to one or more networks. The identification of the networks may be provided in the configuration settings of the package. For example, the package may instruct the network device to connect to various VLANs or other private networks that may be part of a public network (e.g., the Internet). The settings may also define how data flows between the network device and the one or more networks such as data speed, quality of service parameters, security settings, and the like. Stated generally, the configuration package may include all the information a network engineer would typically provide if she were configuring the network device for the first time.

In one embodiment, the ports of the network device may already be coupled to other network devices or endpoints in the network using network cables (e.g., Ethernet cables) even if these cables are not currently transmitting data to the network. That is, a system administrator may have coupled the ports of the network device to other devices before the device is bootstrapped in method 300. Alternatively, after the OS is loaded and executing (e.g., after block 320 is complete), the network device may provide instructions to the user of the mobile device for connecting its ports to other network devices or end points in the network. For example, the package may include instructions that Port A of the network device should be coupled to a neighboring network device in the same rack. The network device may display these instructions on its own user interface or relay the instructions to the mobile device for display. In this manner, the user of the mobile device does not need an in-depth knowledge of how to configure the network device. In this manner, the user can physically couple the network device to other network devices in the network. Again, the network engineer does not need to be present in order to complete the bootstrapping process and connect the ports of the network device to other devices or endpoints in the network.

At block 325, the network device or mobile device may provide a visual or auditory indication to the user of the mobile device that the transfer of the package was successful. Using FIG. 1 as an example, the network device 105 includes indicator lights 110 that illuminate when the transfer of the package via NFC is complete. Furthermore, the indicator lights 110 may flash or turn a different color when the bootstrapping process is complete and the network device is connected to the network. If, however, the lights indicate that the transfer was not successful, the user may bring the mobile device in proximity to the network device a second time to restart the package transfer. In this manner, the user can easily determine whether the package was successfully transferred and/or that the bootstrapping process is complete.

In another embodiment, the application executing on the mobile device, rather than the network device, may inform the user that the package transfer was complete. In this case, the NFC module of the network device may transmit a confirmation message to the mobile device if the package was received successfully. The configuration application can then display this confirmation to the user. Of course, it is also possible that the confirmation can be a sound or a spoken confirmation rather than only a visual confirmation. Moreover, once the bootstrapping process is complete, the network device may transmit a second confirmation message to the mobile device. Because the mobile device may no longer be in close proximity to the network device, the network device may use another communication technique instead of NFC to send the second confirmation message (e.g., Wi-Fi, Bluetooth, email, instant message, etc.).

In one embodiment, the network device may send a confirmation message to the NMS when the bootstrapping process is complete and the network device is now connected to the network. Because the network device now has internet connectivity, the device can send updates to the NMS. Using FIG. 2 as an example, after bootstrapping, network device 105 and computing device 250 may be communicatively coupled such that the NMS 255 can now access and monitor the network device 105 where, before bootstrapping, the NMS 255 could not communicate with the network device 105.

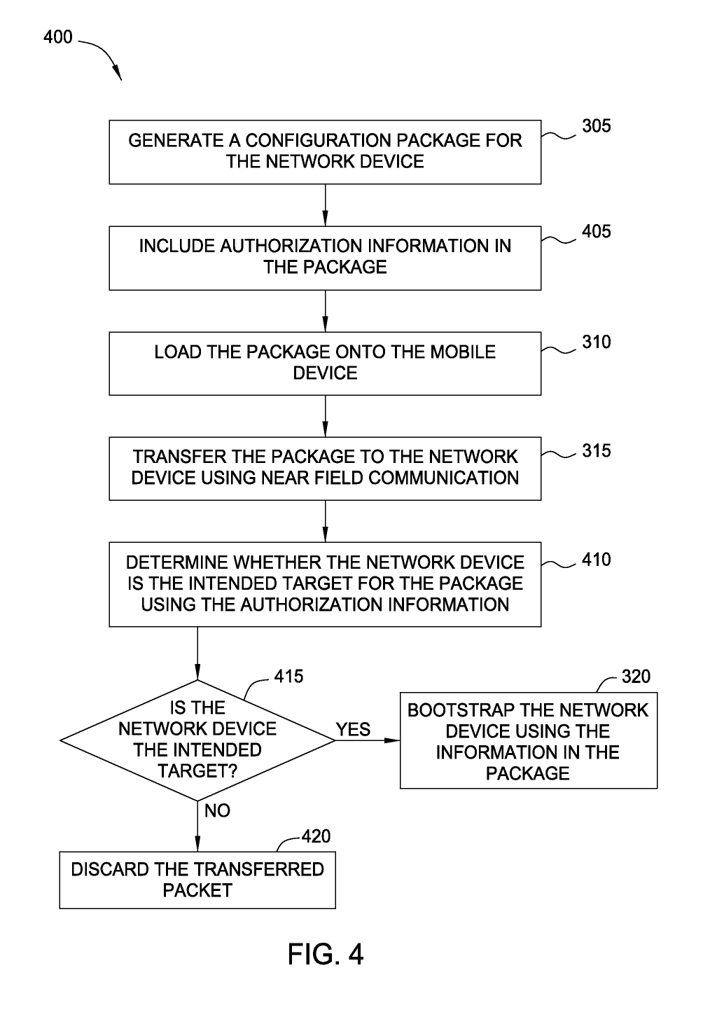

FIG. 4 is a flow chart for using authorization information to load the configuration package onto the intended network device, according to one embodiment described herein. Method 400 includes blocks that are similar to the ones in method 300 of FIG. 3 (and are labeled accordingly). Because these blocks were described above, for the sake of brevity, these descriptions are not repeated here.

Method 400 begins at block 305 where a network engineer may use the NMS to generate a configuration package for the network device. At block 405, the network engineer instructs the NMS to insert authorization information into the package. Because untrained personnel may be tasked with delivering the package to the network device, the authorization information may provide a tool for ensuring the package is delivered to its intended target.

In one embodiment, the authorization information may be program code for decrypting or decoding the information in the configuration package. In one embodiment, in order to decode the package, the network device uses a pre-shared key. This key may be based on, for example, the serial number of the network device. When generating the package, the network engineer may provide the NMS with the serial number of the network devices that should be bootstrapped using the package. The NMS may then generate the authorization information using the serial number and encrypt the package such that only the network device with the same serial number is able to decrypt the package.

In other embodiments, the authorization information may be generated based on different security protocols such as using unique device identifier (UDI) information, secure handshakes, public and private key certificates, and the like. Moreover, the package does not need to be encrypted in order to prevent incorrect network devices from using the package to perform the bootstrapping process. The authorization information may include, for example, a list of network devices that are intended targets of the package. For instance, the authorization information may include a list of UDIs or MAC addresses that uniquely identify the network devices that should receive the package. Before bootstrapping, a network device may check the list to see if its information matches one of the entries in the list. Regardless of the authorization protocol used, the authorization information provides an additional level of security to make sure the package is used to bootstrap only the intended network device or devices.

At block 310, the user of the mobile device uses NFC to load the package onto the network device. Once the network device receives a configuration package from a mobile device at block, at block 410, the network device determines whether it is the intended target of the package using the authorization information. For instance, continuing the pre-shared key example above, the network device uses its serial number to generate a key. If the key is valid, the authorization information may be used to decrypt/decode the package and the network device can begin the bootstrapping process. However, if the key used by the network device does not match the key used by the NMS to encrypt the package, then the network device will be unable to decrypt the package. For example, the user of the mobile device may have transferred the package to the incorrect network device by accident. Nonetheless, because of the authorization information, the network device can independently verify if it is the intended target.

At block 415, the network device determines whether it is the intended target using the authorization information. If so, at block 320, the network device initiates the bootstrap process using the information in the package. If not, at block 420, the network device may discard the transferred packet. In one embodiment, the network device may also inform the mobile device, using the NFC link, that it was not the intended target of the package. The mobile device may then instruct the user to send the package to the correct network device. Additionally or alternatively, the network device may use indicator lights (e.g., a flashing red light) or audio outputs to inform the user that it is not the intended target of the package.

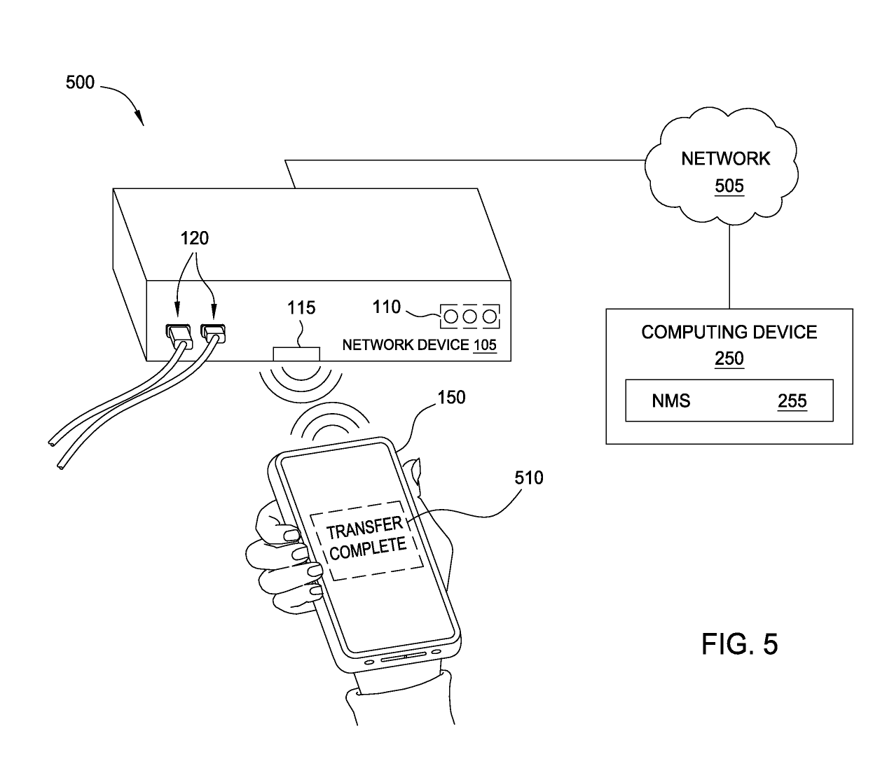

FIG. 5 is a system 500 for connecting a bootstrapped network device to a network, according to one embodiment described herein. Specifically, system 500 illustrates one example of the connectivity that may be achieved following the completion of method 300 of FIG. 3 or method 400 of FIG. 4. That is, the network device 105 in FIG. 5 has been bootstrapped (and possibly rebooted) using the configuration package delivered by the mobile device 150. As shown, the network device 105 is coupled to the network 505 which may be a LAN, a WAN (e.g., the Internet), or a separate network within a LAN or WAN such as a VPN or VLAN. In one embodiment, the information needed to connect to the network device 105 to the network 505 was provided by configuration settings within the package provided by the mobile device 150.

The computing device 250 may also be connected to the network 505. As such, the network device 105 can send a confirmation message to alert the NMS 255 that the bootstrapping process was successful. The NMS 255 may then update its records to add the network device 105 as a functional element in the network 505. The NMS 255 may also inform the network engineer who designed the configuration package that the bootstrapping process was successful.

The network device 105 may also inform the mobile device 150 that the bootstrapping process was successful. For example, the user may keep the mobile device 150 within close proximity to the network device 105 while the configuration package is transferred and the bootstrapping process is performed. The network device 105 then uses the NFC module 115 to send a confirmation message to the mobile device after the bootstrapping process completes successfully. The mobile device 150 may the display this confirmation message 510 to the user. Doing so frees the user to perform other tasks—e.g., load the same (or different) package onto other network devices. Of course, instead of using NFC to transmit the confirmation message, the network device 105 (which now has network connectivity) can use email, SMS message, or other communication means to send the confirmation message to the mobile device 150. Thus, the user may be able to move the device 150 beyond the range of NFC after transferring the package and still be informed when the bootstrapping process is complete.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In view of the foregoing, the scope of the present disclosure is determined by the claims that follow.

We claim:

1. A network device, comprising:
a near field communication (NFC) module configured to detect a NFC-enabled remote computing device and receive, using NFC, a configuration package from the remote computing device comprising an operating system image and network configuration settings; and
a processing element configured to perform a bootstrapping process using the operating system image and connect the network device to a network using the network configuration settings in the received package.

2. The network device of claim 1, wherein during the bootstrapping process the processing element installs an operating system associated with the operating system image.

3. The network device of claim 1, wherein, before receiving the package, the network device was not coupled to the network, and wherein the configuration package is received and the bootstrapping process is performed automatically without user input.

4. The network device of claim 1, further comprising ports configured to facilitate data communication with the network, the ports are configured using the network configuration settings in the configuration package.

5. The system of claim 1, wherein, after completing the bootstrapping process, the network device is configured to transmit a message to a network management system via the network to indicate the bootstrapping process is complete.

6. The system of claim 1, wherein the network device provides a sensory indication after the configuration package is transferred to the network device.

7. The system of claim 1, wherein the package includes authorization information for determining whether the network device is an intended recipient of the package.

8. The system of claim 1, wherein, during the bootstrapping process, the operating system image is used to install an operating system for the network device and access information in the network configuration settings of the package are used to connect the network device to the network.

9. A method, comprising:
receiving a configuration package on a mobile computing device, the package comprising an operating system image and network configuration settings for a network device, wherein the operating system image is configured to be used when performing a bootstrapping process in the network device and the network configuration settings are configured to connect the network device to a network; and
transferring the package from the mobile computing device to the network device using NFC.

10. The method of claim 9, further comprising:
transmitting for display an indication to a user of the mobile device after the transfer of the package from the mobile computing device to the network device is successful.

11. The method of claim 9, wherein the network device has not previously been configured to connect to any network.

12. The method of claim 9, wherein the package comprises authorization information for determining whether the network device is an intended recipient of the package.

13. The method of claim 12, wherein the authorization information includes a pre-shared key based on a serial number of the network device, the pre-shared key is configured to be used by the network device to decode the package.

14. The method of claim 9, further comprising, in response to receiving the configuration package, bootstrapping the network device by loading an operating system on the network device using the operating system image and connecting the network device to the network using access information in the network configuration settings of the package.

15. A computer program product, comprising:
computer-readable program code configured to:
receive a configuration package on a mobile computing device, the package comprising an operating system image and network configuration settings for a network device, wherein the operating system image is configured to be used when performing a bootstrapping process in the network device and the network configuration settings are configured to connect the network device to a network, and
transfer the package from the mobile computing device to the network device using NFC; and
a computer readable storage medium that stores the computer-readable program code.

16. The computer program product of claim 15, wherein the program code is configured to transmit for display an indication to a user of the mobile device after the transfer of the package from the mobile computing device to the network device is successful

17. The computer program product of claim 15, wherein the network device has not previously been configured to connect to the network.

18. The computer program product of claim 15, wherein the package comprises authorization information for determining whether the network device is an intended recipient of the package.

19. The computer program product of claim 15, wherein the authorization information includes a pre-shared key based on a serial number of the network device, the pre-shared key is configured to be used by the network device to decode the package.

20. The computer program product of claim 15, wherein the operating system image is configured to load an operating system onto the network device and the network configuration settings include access information for connecting the network device to the network.
